(19) United States
(12) Patent Application Publication
(10) Pub. No.: US 2004/0014926 A1
(43) Pub. Date: Jan. 22, 2004

(54) Method for providing wooden substrates with high resistance against attack from chemical products

(76) Inventors: Vincent Grainer, Nogent-Sur-Marne (FR); Uwe Wustmann, Meersbusch (DE)

Correspondence Address: BURNS DOANE SWECKER & MATHIS L L P, POST OFFICE BOX 1404, ALEXANDRIA, VA, 22313-1404, US

(21) Appl. No.: 10/380,671

(22) PCT Filed: Sep. 17, 2001
(86) PCT No.: PCT/FR01/02884

(30) Foreign Application Priority Data
Sep. 18, 2000 (FR) 00/11884

(51) Int. Cl. C08G 18/00

(52) U.S. Cl. 528/44; 428/423.1

(57) ABSTRACT

The invention concerns a method for providing a substrate comprising a wooden surface with a coating having high properties of resistance against attack from chemical products. The invention is characterised in that it comprises steps which consist in: a) adding to an aqueous polyol suspension a composition based on isocyanate(s) and an anionic surfactant having a hydrophilic part comprising an anionic group and a lipophilic part comprising a hydrocarbon radical, said surfactant also including a fragment of polyethylene and/or propylene glycol chain of at least 1, advantageously at least 5, preferably at least 7 ethylenyloxyl and/or propylenyloxyl units, and said isocyanate composition comprising not more than 30% by volume of surfactant bound to an isocyanate function, to form an isocyanate emulsion in water, b) applying said mixture to the surface of said wooden substrate; c) allowing said isocyanate(s) to react with said polyol to form a polyurethane coating.

The invention relates to a process intended to confer on wooden substrates or substrates having a wooden surface a coating exhibiting a high resistance to attack by chemicals.

A more particular subject matter of the invention is the preparation of coatings exhibiting the properties listed above on internal wooden surfaces, in particular for domestic or public use, such as floors, doors, walls, skirting boards, furniture or interior trim of motor vehicles.

Wooden surfaces are subject to attack by many chemicals and have to be protected by the application of a paint or varnish coating.

Mention may in particular be made, as chemicals which damage the appearance of internal wooden surfaces, of maintenance products, in particular detergents used to clean the surfaces, fatty products and also certain foods, such as coffee, mustard, vinegar, milk or wine, in particular red wine.

Mention may in particular be made, among fatty products which damage the appearance of wooden surfaces, of cosmetic creams and sunscreens, which, when they come into contact with wooden surfaces, generally accidentally, leave marks, stains or films on the surface of the latter which are very difficult to remove, including when these surfaces have a protective coating, such as a varnish.

To protect wooden surfaces, it is known to coat them with paint or varnishes of polyurethane type.

These coatings are formed by applying, to the surface to be protected, a composition comprising a polyol and an isocyanate curing agent, the isocyanate functional groups of which react with the hydroxyl functional groups of the polyol to form a polyurethane network.

Because of the sensitivity of wood to heat, the coatings obtained are dried at room temperature, indeed even at a higher temperature but not exceeding 60° C.

To this end, it is necessary to employ “2K” systems for two components, the polyol resin forming part of the first component and the isocyanate forming part of the second component.

The two components are mixed shortly before the application of the composition, in order to avoid the formation of a network before the application of the coating.

The polyol and the curing agent can be in solution, suspension or emulsion.

Because of the change in legislation relating to the use of volatile organic solvents, in particular for domestic use, and also because of environmental concerns, the current tendency is to avoid the use of organic solvents and to apply, to the surfaces to be treated, aqueous emulsions comprising the polyol, to which emulsions the curing agent is added before use.

One of the major problems encountered with the type of emulsion of the invention is the difficulty of manual incorporation of the curing agent in the aqueous polyol emulsion because of the differences in viscosity between the isocyanate composition and the polyol.

Indeed, for coating applications on household surfaces, the isocyanate component and the polyol component are generally mixed manually by the user before application without recourse to mechanical mixing devices.

Because of the hydrophobicity of the isocyanate component, it is generally necessary to confer hydrophilizing properties on the latter or to have recourse to special equipments exerting high shear forces in order to introduce the hydrophobic isocyanate component into the aqueous phase.

Another solution is to modify the (poly)isocyanate in order to render it hydrophilic and therefore dispersible or self-emulsifiable in water.

The document U.S. Pat. No. 5,252,696 provides, to this end, for the grafting of hydrophilic polyether groups to the polyisocyanate by reaction of a hydroxyl group of the polyether with the NCO functional group of the polyisocyanate.

However, the coatings obtained with aqueous emulsions of polyol and of isocyanate(s) generally only exhibit an inadequate mediocre resistance to attack by chemicals.

One aim of the present invention is to make available a process for conferring, on a substrate having a wooden surface, a coating of polyurethane type starting from an unblocked composition comprising isocyanate(s) or a composition exhibiting a low degree of blockage, acting as curing agent, which can be incorporated without difficulty in an aqueous polyol emulsion, in particular manually.

One aim of the invention is in particular to provide a process of the type described above starting from a composition comprising isocyanate(s) which can be incorporated without difficulty in an aqueous polyol emulsion, without it being necessary to lower the viscosity of the composition comprising isocyanate(s) by incorporation of high proportions of organic solvent.

Another aim of the invention is to make available a process of the type described above starting from an unmasked or weakly masked composition comprising isocyanate(s) which, after incorporation in an aqueous polyol emulsion and application to the substrate exhibiting a wooden surface, makes it possible to obtain a coating having a high hardness.

Yet another aim is to provide a process of the type described above starting from a composition comprising isocyanate(s) of the type mentioned above in which the coating exhibits a good surface appearance.

Another aim of the invention is to make available a process of the type described above starting from a composition comprising isocyanate(s) exhibiting a high resistance to attack by chemicals.

WO 97/31960 discloses a composition based on isocyanate which is self-dispersible in an aqueous phase and which is of use for the application of paints and varnishes.

This document mentions the application of this type of isocyanate for the coating of steel sheets by production of a polyurethane film.

Generally, the uses of curing agents of this type are the coatings of car bodies or exterior steel structures, such as bridges, steel structural work, and the like.

The studies of the inventors which are the source of the present invention have allowed it to be discovered that the compositions comprising isocyanates as disclosed in WO 97/31960 surprisingly gave, when they were applied to wooden surfaces, excellent results, in particular a high hardness and a high resistance to attack by chemicals.

A subject matter of the invention is a process for conferring, on a substrate comprising a wooden surface, a coating having properties of high hardness and of high resistance to attack by chemicals, characterized by the stages consisting in:

a) adding, to an aqueous suspension of a polyol, a composition based on isocyanate(s) and an anionic surface-active agent exhibiting a hydrophilic part comprising an anionic group and a lipophilic part comprising a hydrocarbon radical, said surfactant also comprising a fragment of polyethylene and/or polypropylene glycol chain of at least 1, advantageously of at least 5, preferably at least 7, ethylenyloxyl and/or propylenyloxyl units, and said composition comprising isocyanate(s) not comprising more than 30% by mass of surface-active agent in the form bonded to an isocyanate functional group, to form an emulsion of isocyanate(s) and of polyol in water;

b) applying said mixture to the wooden surface of said substrate;

c) allowing said isocyanate(s) to react with said polyol to form a polyurethane coating.

The surface-active agent can be present in the polyol composition or in the (poly)isocyanate composition or can be added to the aqueous suspension of the polyol at the same time as the isocyanate composition.

However, it is preferable for the surface-active agent to be present in the composition based on isocyanate(s).

The surfactant is advantageously selected so that it does not comprise a functional group which is reactive with the (poly)isocyanate so as to be present in the suspension in an essentially free form, in contrast to a form bonded via a chemical bond with the (poly)isocyanate.

The term “essentially free form” means that less than 30%, advantageously less than 20%, preferably less than 10%, by mass of the surface-active agent is in the bonded form.

According to a preferred embodiment, the anionic surface-active agent exhibits at least one functional group selected from sulfates or phosphates of aryl(s) and/or of alkyl(s) or aryl- or alkyl-phosphonates, -phosphinates and sulfonates.

The anionic surface-active agent preferably comprises a hydrophilic part formed from said anionic functional group, from said fragment of polyethylene glycol and/or polypropylene glycol chain and from a lipophilic part based on a hydrocarbon radical.

The lipophilic part is preferably selected from alkyl and aryl groups, preferably C₆-C₃₀ alkyl and aryl groups.

Preference is very particularly given to an anionic surface-active agent corresponding to the following formula:

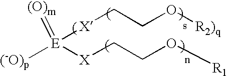

in which:

q is zero or 1;

p is an integer equal to 1 or to 2;

m is zero or an integer equal to 1 or to 2;

X and X′, which are identical or different, each represents an arm comprising at most two carbon chain members;

s is zero or an integer between 1 and 30, advantageously between 5 and 25, preferably between 9 and 20 (closed ranges, that is to say comprising the limits);

n is zero or an integer selected between 1 and 30, advantageously between 5 and 25, preferably between 9 and 20 (closed ranges, that is to say comprising the limits);

E is an element selected from phosphorus and sulfur;

R₁ and R₂, which are identical or different, each represents a hydrocarbon radical advantageously selected from C₆-C₃₀ aryls and C₁-C₂₀ alkyls which are optionally substituted, advantageously optionally substituted C₁₀-C₂₀ alkyls.

Although this does not form part of the preferred compounds, it should be noted that s and/or n can be equal to zero, provided that E is phosphorus, and that, when s and n are equal to zero, respectively R₁ and/or R₂ are C₈ to C₁₂ alkyls, which are advantageously branched, or C₁₂ to C₁₆ aralkyls or C₁₀ to C₁₄ alkylaryls.

One of the divalent radicals X and X′ can also be a radical of ([EOₘ(O⁻)ₚ]) type, so as to form pyroacids, such as symmetrical or unsymmetrical diesters of pyrophosphoric acid.

The total carbon number of the anionic compounds targeted by the present invention is advantageously at most approximately 100, preferably at most approximately 50.

The divalent radicals X and optionally X′ are advantageously selected from the following divalent radicals (the left-hand part of the formula being bonded to E):

when E is P, one of the X or X′ radicals can be O—P(O)(O⁻)—X″—;

when E is P, one of the X or X′ radicals can be —O—(R₁₀—O)P(O)—X″; R₁₀ being a C₂ to C₃₀ hydrocarbon residue comprising one or more ethylenyloxyl or propylenyloxyl units, advantageously at least 5, preferably at least 7, ethylenyloxyl or propylenyloxyl units, and X″ being an oxygen atom or a single bond;

a direct bond between E and the first ethylene of said fragment of polyethylene glycol chain;

a methylene which is optionally substituted and, in this case, advantageously partially functionalized;

an arm with the structure —Y—, -D-Y—, —Y-D- or —Y-D-Y′, in which

Y and Y′, which are identical or different, are a chalcogen advantageously selected from the lightest, namely sulfur and especially oxygen, or metalloid elements from the atomic rows at most equal to that of phosphorus and belonging to Group VB in the form of tertiary amine or phosphine derivatives, the radical providing the tertiary nature advantageously having at most 4 carbon atoms, preferably at most 2 carbon atoms;

D is an optionally substituted, including functionalized, alkylene, D advantageously being ethylene or methylene, preferably ethylene in the structures -D-Y— and especially —Y-D-Y′ and methylene in the structures —Y-D-.

When E is phosphorus, the formula (I) becomes the formula (II):

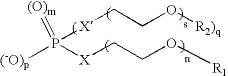

which, when q is zero, becomes:

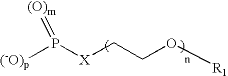

in which formulae

p is zero or an integer equal to 1 or to 2;

m is zero or an integer equal to 1 or to 2;

the sum p+m+q is at most equal to three;

the sum 1+p+2 m+q is equal to three or to five;

X and X′, which are identical or different, each represents an arm comprising at most two carbon chain members;

n is an integer between 5 and 30, advantageously between 5 and 25, preferably between 9 and 20 (closed ranges, that is to say comprising the limits);

R₁ and R₂, which are identical or different, each represents a hydrocarbon radical advantageously selected from the aryls and alkyls as defined above which are optionally substituted, in particular by halogen atom, preferably fluorine atom.

In the preceding formulae, the ethyleneoxyl groups can be partially replaced by propyleneoxyl groups.

However, it is desirable, in this case, for the compounds to comprise predominantly ethyleneoxyl groups.

The Periodic Table of the Elements used in the present application is that of the Supplement to the Bulletin de la Société Chimique de France, January 1966, No. 1.

The optional functionalization of the alkylenes and in particular methylenes (X and X′) is carried out by hydrophilic functional groups (tertiary amines and other anionic functional groups, including those which are described above [EOₘ(O⁻)ₚ]).

The countercation is advantageously monovalent and is selected from inorganic cations and organic cations, advantageously nonnucleophilic, of quaternary or tertiary nature, in particular “oniums” from Group V, such as phosphonium, ammonium, or from Group VI, such as sulfonium, and the like, and their mixtures. Preference is given to countercations of ammonium type resulting from an amine, advantageously a tertiary amine. In addition, it is preferable to avoid the organic cation having a hydrogen which reacts with the isocyanate functional group.

The inorganic cations can be sequestered by phase transfer agents, such as crown ethers.

The pKₐ of the organic or inorganic cations is advantageously between 8 and 12.

The cations and in particular the amines corresponding to the ammoniums advantageously do not exhibit a surfactant property but it is desirable for them to exhibit a good solubility which is in any case sufficient to ensure the solubility, in the aqueous phase and at the concentration of use, of said compounds comprising an anionic functional group and advantageously a fragment of polyethylene glycol chain. Tertiary amines exhibiting at most 12 carbon atoms, advantageously at most 10 carbon atoms, preferably at most 8 carbon atoms, per “onium” functional group are preferred. The amines may or may not comprise other functional groups and in particular functional groups corresponding to the functional groups of amino acids and cyclic ether functional groups, such as N-methylmorpholine. These other functional groups are advantageously in a form which does not react with the isocyanate functional groups and do not detrimentally affect to a significant extent the solubility in the aqueous phase.

Triethylamine is a preferred amine.

It is very desirable for the anionic compounds according to the present invention to be in a neutralized form so that the pH induced during dissolution in water or during bringing into contact with water is at least equal to 3, advantageously to 4, preferably to 5, and at most equal to 12, advantageously to 11, preferably to 10.

When E is phosphorus, it is desirable to use mixtures of monoester and of diester in a molar ratio of between 1/10 and 10, advantageously between ¼ and 4. Such mixtures can additionally comprise from 1% up to approximately 20%, but preferably not more than 10%, by mass of phosphoric acid and from 0 to 5% of esters of pyrophosphoric acid. The phosphoric acid is advantageously salified at least partially salified, so as to be in the recommended pH regions.

In the mono- and diesters, a portion of the ethyleneoxyl groups can be replaced by propyleneoxyl groups. Nevertheless, it is preferable for the ethyleneoxyl groups to be predominant.

The (poly)isocyanate according to the invention consists of any isocyanate and (poly)isocyanate. The preferred (poly)isocyanates are selected from the products of homo- or heterocondensation of alkylene diisocyanates comprising in particular products of the “Biuret” type and of the “Trimers” type, indeed even “Prepolymers” type, with isocyanate functional group comprising in particular urea, urethane, allophanate or ester amide functional groups, and from the mixtures comprising them.

They can be, for example, polyisocyanates marketed by Rhodia, France, under the name “Tolonate”.

Generally, the preferred polyisocyanates are the products of homo- or heterocondensation of the following isocyanate monomers:

1,6-hexamethylene diisocyanate,

1,12-dodecane diisocyanate,

cyclobutane 1,3-diisocyanate,

cyclohexane 1,3 and/or 1,4-diisocyanate,

1-isocyanato-3,3,5-trimethyl-5-diisocyanato-methylcyclohexane (isophorone diisocyanate), IPDI),

2,4 and/or 2,6-hexahydrotoluylene diisocyanate,

hexahydro-1,3- and/or 1,4-phenylene diisocyanate,

perhydro-2,4′- and/or 4,4′-diphenylmethane diisocyanate,

1,3- and/or 1,4-phenylene diisocyanate,

2,4- and/or 2,6-toluylene diisocyanate,

diphenylmethane 2,4′- and/or 4,4′-diisocyanate,

4-isocyanatomethyloctylene diisocyanate (LTI or NTI),

triphenylmethane 4,4′4″-triisocyanate,

1,3-bisisocyanatomethylcyclohexane,

bis-isocyanatomethyl norbornane (NBDI),

2-methylpentamethylene diisocyanate.

It is not necessary to add an organic solvent to the isocyanate composition comprising the surface-active agent.

However, to lower the viscosity of the composition or to improve the optical properties of the film, a certain amount of organic solvent may be added.

Nevertheless, it is preferable for the composition to comprise at most 50%, advantageously at most 40%, more preferably at most 35%, by mass of organic solvent with respect to the mass of the combined isocyanates, depending on the nature of the polyol to which the composition is intended to be added.

As regards the appropriate solvents, mention may be made of methoxypropyl acetate, butyl acetate, propylene dimethyl glycol, for example marketed under the name Proglyde DMM® of Dow, or ketones, propylene glycol diacetate, ethyl 3-ethoxypropionate or butyl ethylene glycol acetate.

The ratio by mass of the isocyanates to the anionic surface-active agent is generally at most equal to 1/3, advantageously at most equal to 20%, preferably to 10%.

The ratio by mass of the isocyanates to the surface-active agent is advantageously greater than 1%, preferably than 2%.

It is also desirable for the amount of said surface-active agent or agents to correspond to a value of between 10-2 and 1, advantageously between 5×10⁻² and 0.5 atom of E per liter.

Thus, the ratio by mass of the isocyanates to said surface-active agent is advantageously at least equal to 2%, preferably to 4%, and at most equal to approximately 20%, preferably to approximately 10%; thus, this ratio by mass is advantageously between 2% and approximately 20%, preferably between 4 and approximately 10%.

According to the present invention, said surface-active agent can be used alone or as a mixture with one or more surface-active agents. The latter can be agents also meeting the above obligation to comprise an anionic functional group and advantageously a fragment of polyethylene glycol chain, preferably of at least 5 ethylene oxide units.

These optional surface-active agents can also be selected from other ionic compounds and from nonionic compounds those blocked or not blocked at the chain end. However, the nonionic compounds exhibiting alcohol functional groups on at least one of the chains appear to have a slightly unfavorable effect on the (self)emulsion, even if they have a favorable effect on other aspects of the paint composition; in view of this, it is preferable for the content of this type of compound to represent at most one third, advantageously at most one fifth, preferably at most one tenth, by mass of said anionic compounds according to the invention.

The ratio by mass between the surface-active compounds, said anionic compound defined above and the isocyanates is very preferably between 4 and approximately 10%.

The composition can additionally comprise an advantageously latent catalyst (which can be released by the action of external agents, for example visible or UV radiation or oxygen).

The polyol is in an aqueous medium in a water-soluble or water-dispersible form.

It can be an aqueous solution, which can in particular be obtained after neutralization of the ionic groups, or an emulsion of the polymer in water or a dispersion of latex type.

The (poly)isocyanate composition, if appropriate comprising the surface-active agent as defined in the present invention, is added to the aqueous polyol emulsion advantageously manually, the mixture being stirred using a spatula.

This emulsification is advantageously carried out at a temperature of less than 50° C., preferably at room temperature. It is desirable to carry out, if necessary, an adjustment of the pH to achieve a value at least equal to 3 and at most equal to 11, preferably of between 4 and 10, during the emulsification.

According to an advantageous alternative form of the present invention, the pigments, in particular titanium bioxide, are dispersed in the polyol(s) before the addition of the isocyanate.

According to a preferred embodiment of the present invention, after dispersing or emulsifying, the sum of the constituents in water varies from 30 to 70% by mass with respect to the whole of the composition.

However, during the study which led to the present invention, in particular in the case of aliphatic isocyanates, it was shown that there is a risk of various reactions running away when certain proportions of water are reached. Consequently, it is sensible to avoid compositions where the ratio by mass of, on the one hand, the amount of water to, on the other hand, the sum of the isocyanate and of the surfactant according to the invention in the aqueous phase is between 10⁻² and a half. If greater security is desired, ratios of between 10⁻³ and 1 will be avoided.

The polyol used in the context of the invention is a polymer which comprises at least two hydroxyl groups (phenol or alcohol groups) advantageously having a hydroxyl level between 0.5 and 5%, advantageously between 1 and 3%, by mass of resin.

These polyols can be acrylic in nature or of polyester, polyurethane, alkyd or hybrid nature, in particular polyester urethane and acrylic urethane nature.

It has been found, surprisingly, that the excellent chemical resistance properties obtained with the isocyanate composition of the invention are observed whatever the nature of polyol envisaged, whereas generally the properties of a coating depend on the polyisocyanate/polyol pair.

A preferred polyol is a dispersion of aliphatic polyurethane modified by a fatty acid, marketed by Alberdingk Boley under the name Alberdingk Cur 99®.

Another polyol is a polyester polyurethane dispersion, marketed by Alberdingk under the name Alberdingk U915®.

Other polyols which have given good results are:

the polyol Primal E-3275@ from Röhm & Haas,

the polyol Alberdingk AC 31® from Alberdingk,

the polyol Alberdingk Cur 60® from Alberdingk.

The molar ratio of the free isocyanate functional groups to the hydroxyl functional groups is between 0.5 and 2.5, advantageously between 0.8 and 1.6, preferably between 1 and 1.4.

The aqueous polyol suspension or emulsion to which the (poly)isocyanate composition and the surface-active agent as defined above are added is, after homogenization, applied to the substrate to be coated.

It is desirable to apply the suspension or the emulsion after a period not exceeding a few hours, advantageously four hours, after the addition of the (poly)isocyanate to the aqueous polyol emulsion.

The mixture is applied by any known means conventionally used for wooden surfaces, in particular household surfaces, especially with a roller, with a paint brush, with a brush or indeed even with a compressed air gun, for certain specific applications.

It is generally preferable to apply several coats, advantageously two or three coats, to the substrate to be coated.

Advantageously, the coating is applied over a thickness, after drying, of between 5 and 150 μm, advantageously between 30 and 100 μm. It is generally preferred to dry the coating after application at a temperature of 20 to 60° C. for a time which can range from 15 minutes to 48 hours.

Whatever the nature of the polyol, the coating obtained after drying, in particular paint or varnish, exhibits an excellent hardness and a high resistance to attack by chemicals, cosmetics and foodstuffs.

Thus, the chemical resistance characteristics are particularly excellent for solvents, such as dibutyl phthalate, ethyl alcohol or acetone, highly colored foodstuffs, such as coffee, red wine or mustard, or fatty products, such as cosmetic creams.

The properties of hardness and of chemical resistance are observed for various woods, in particular pine, fir, spruce, ash, maple, mahogany, beech, and the like.

The examples presented below illustrate the invention.

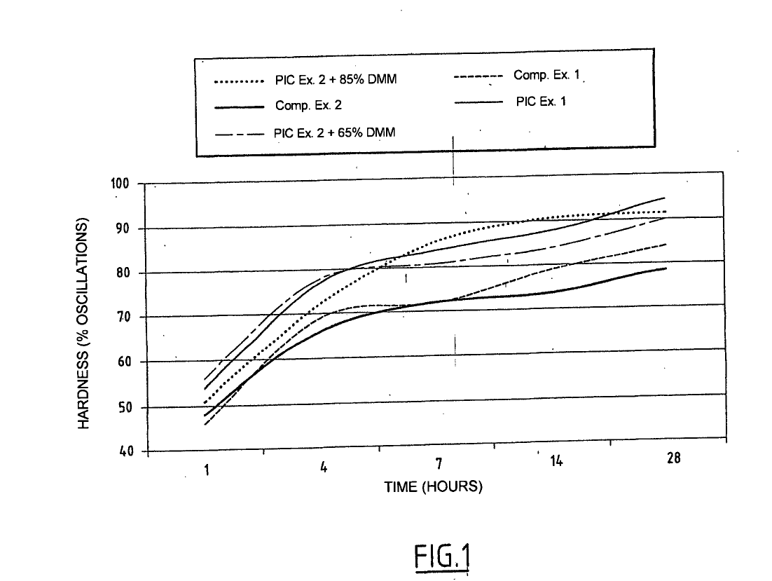

In order to understand these, reference will be made to the appended FIGS. 1 to 4, in which:

FIG. 1 represents the hardness results obtained by employing a polyisocyanate composition according to the invention;

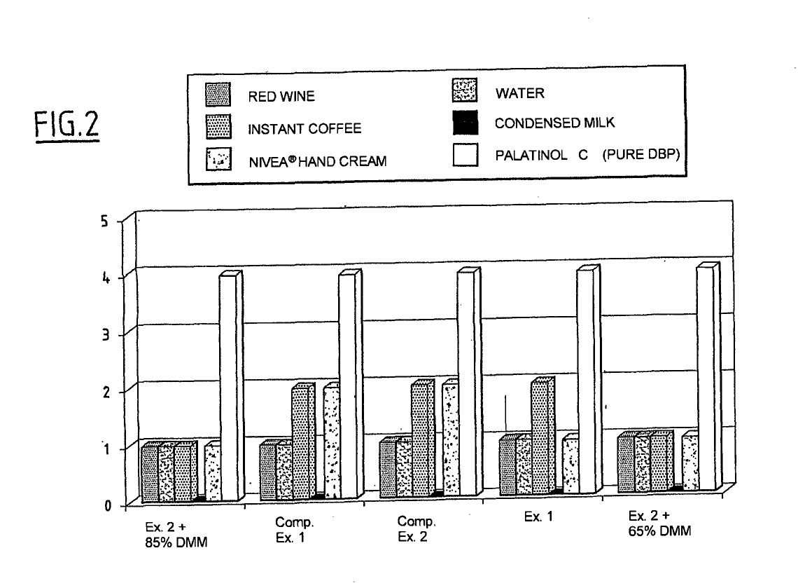

FIG. 2 represents the chemical resistance results for a polyisocyanate composition according to the invention;

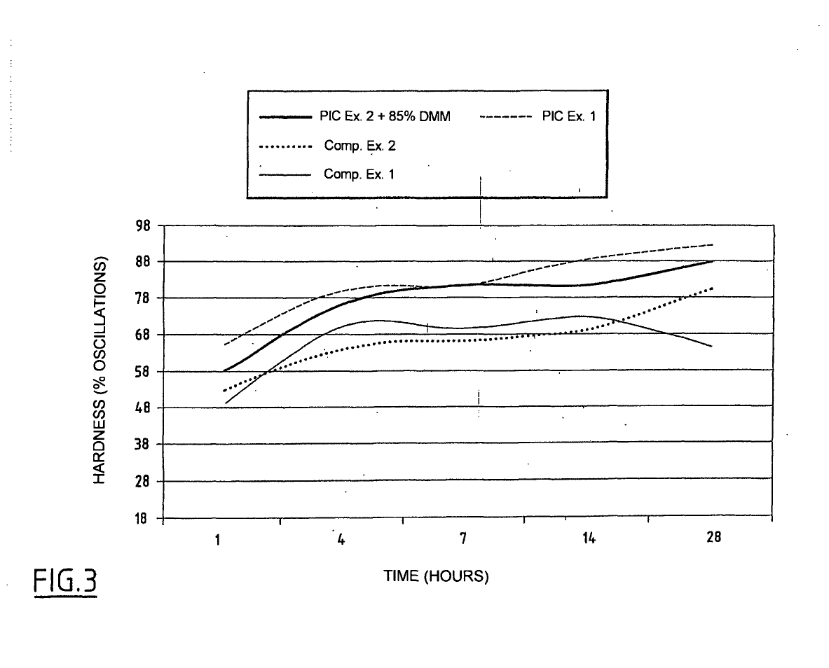

FIG. 3 represents the hardness results obtained by employing another polyisocyanate composition according to the invention;

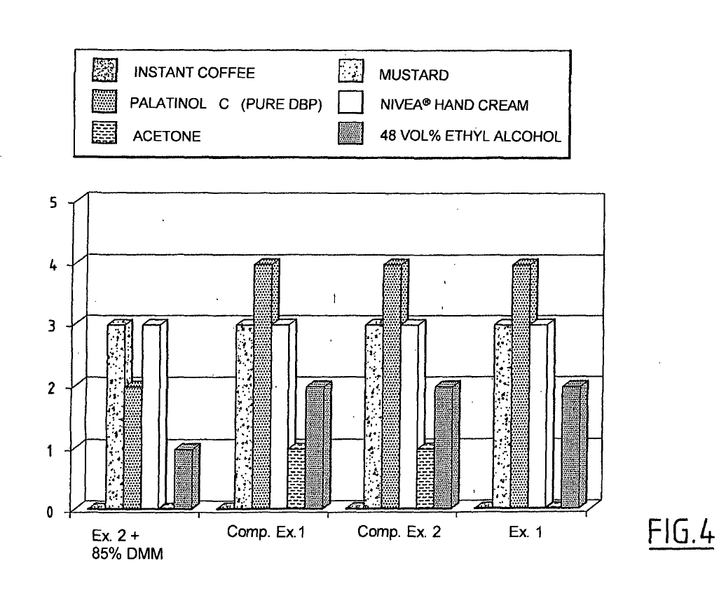

FIG. 4 represents the chemical resistance results obtained by employing another polyisocyanate composition according to the invention.

The hardness is measured as König hardness after a pot life of one hour, the coating being applied to a glass sheet using a film-spreader over a thickness of 30 μm for FIG. 1 and 40 μm for FIG. 3.

The chemical resistance properties are measured on the coatings applied to a Siberian stone pine substrate, immediately after mixing the components (isocyanate and polyol). Evaluation is carried out according to a grading from 0 to 5 (DIN Standard 68 861, the grade 0 equivalent to excellent performances and the grade 5 to mediocre performances). The test products are red wine, soluble coffee, Nivea® cream, water, condensed milk, dibutyl phthalate, acetone, mustard and 48% by volume ethyl alcohol.

Rhodofac® RE610 is a mixture of phosphoric mono and diesters according to the formula II and the mean formula of its hydrocarbon radical is a polyethoxylated (˜ten times) nonylphenol. The molar ratio of monoester to diester is approximately 1 (rounded mathematically). Likewise, Rhodafac® PA17 exhibits, as product according to the present invention, a mixture of phosphoric mono and diesters according to the formula II and the mean formula of its hydrocarbon radical is a polyethoxylated (˜five-six times) nonylphenol.

### EXAMPLE 1

Preparation of a (Poly)Isocyanate Composition According to the Invention

165 g of Tolonate® HDT (trimer-based isocyanurate oligomer) are mixed with 24 g of butyl acetate and 13 g of Rhodafac® RE610 (mixture of phosphoric mono and diesters according to the formula II) and 3 g of triethylamine. This mixture is stirred using a frame or defloculating paddle for 5 minutes at 100 revolutions/minute. This mixture has a viscosity of 0.84 Pa·s at 20° C. and a coloring of less than 100 APHA.

### EXAMPLE 2

The mixture is prepared with 92 g of Tolonate® HDT and 10 g of Rhodofac RE610 and 2.3 g of triethylamine. The viscosity of this mixture is 5.2 Pa·s at 20° C. and the coloring is less than 100 APHA.

### EXAMPLE 3

Working Examples

An aqueous polyol suspension (component 1) is prepared which has the following composition (in the order of addition of the components):

| | |
|---|---|
| Alberdingk U 915 ® (37.1%) | 39.1 |
| Butyl glycol | 2.7 |
| Butyl diglycol | 2.7 |
| Water | 7.75 |
| Byk ® 028 | 1.1 |
| Byk ® 346 | 0.15 |
| Acrysol ® RM 8 | 1 |
| Acrysol ® RM 1020 | 0.5 |
| Alberdingk ® U 915 (37.1%) | 45 |
| Total | 100 |

A mixture of the composition of example 3 with the isocyanate composition of example 1 or 2 and two isocyanate compositions of the state of the art (comparative examples) is prepared in order to obtain the following final compositions:

| Curing agent | 1 | 3 | 4 | 5 | 6 |
|---|---|---|---|---|---|
| Composition ex. 2 | 85 | | | | 65 |
| Compound of the state of the | | 85 | | | |
| art 1* | | | | | |
| Compound of the state of the | | | 65 | | |
| art 2** | | | | | |
| Composition ex. 1 | | | | 100 | |
| Proglyde DMM ® | 15 | 15 | 35 | | 35 |
| Amount component 1 (% by | 9 | 9 | 10 | 9 | 10 |
| mass) | | | | | |

*isocyanurate oligomer comprising approximately 100% of surfactant comprising a polyether chain grafted to the isocyanate functional group
**isocyanurate oligomer comprising approximately 100% of surfactant comprising a polyether chain grafted to the isocyanate functional group

The mixtures obtained are applied to a wooden substrate (Siberian stone pine substrate) in three successive coats, each with a thickness of 30 μm (after drying).

The König hardness and the resistance to attack by various chemicals, cosmetics or foodstuffs according to DIN Standard 68861 are evaluated for each coating.

The results are represented in FIG. 1 (hardness) and FIG. 2 (chemical resistance).

### EXAMPLE 5

Working Examples

An aqueous polyol suspension (component 1) is prepared which has the following composition (in the order of addition of the ingredients):

| | |
|---|---|
| Alberdingk Cur 99 ® (34.7%) | 30 |
| Worlee WO 604 N | 0.5 |
| Dowanol DPM | 2 |
| Ethyl diglycol | 3 |
| Water | 6 |
| Byk ® 333 | 0.2 |
| Byk ® 346 | 0.3 |
| Acrysol ® RM 2020 | 0.5 |
| Alberdingk ® Cur 99 (34.7%) | 57.5 |
| Total | 100 |

A mixture of the composition of example 3 with the isocyanate composition of example 1 or 2 and two isocyanate compositions of the state of the art (comparative examples) is prepared in order to obtain the following final compositions:

| Curing agent | 1 | 3 | 4 | 6 |
|---|---|---|---|---|
| Composition ex. 2 | 85 | | | |
| Compound of the state of the art | | 85 | | |
| 1* | | | | |
| Compound of the state of the art | | | 65 | |
| 2** | | | | |
| Compound ex. 1 | | | | 100 |
| Proglyde DMM ® | 15 | 15 | 35 | |
| Amount component 1 (% by mass) | 9 | 9 | 10 | 9 |

*isocyanurate oligomer comprising approximately 100% of surfactant comprising a polyether chain grafted to the isocyanate functional group
**isocyanurate oligomer comprising approximately 100% of surfactant comprising a polyether chain grafted to the isocyanate functional group

The mixtures obtained are applied to a wooden substrate (Siberian stone pine substrate) in three successive coats, each with a thickness of 30 μm (after drying).

The König hardness and the resistance to various anionic products, cosmetics or foodstuffs according to DIN Standard 68861 are evaluated for each coating.

The results are represented in FIG. 3 (hardness) and in FIG. 4 (chemical resistance).

In all cases, the final hardness of the coating obtained is higher for the isocyanate compositions of the invention than for the isocyanate compositions of the coatings of the invention of the state of the art.

The chemical resistance is improved by a factor of 1 to 2 with respect to the coatings obtained with polyisocyanate compositions of the state of the art.

1. A process for conferring, on a substrate comprising a wooden surface, a coating having good properties of resistance to attack by chemicals, characterized by the stages consisting in:
a) adding, to an aqueous suspension of a polyol, a composition based on isocyanate(s) and an anionic surface-active agent exhibiting a hydrophilic part comprising an anionic group and a lipophilic part comprising a hydrocarbon radical, said surfactant also comprising a fragment of polyethylene and/or polypropylene glycol chain of at least 1, advantageously of at least 5, preferably at least 7, ethylenyloxyl and/or propylenyloxyl units, and said composition comprising isocyanate(s) not comprising more than 30% by mass of surface-active agent in the form bonded to an isocyanate functional group, to form an emulsion of isocyanate(s) in water;
b) applying said mixture to the wooden surface of said substrate;
c) allowing said isocyanate(s) to react with said polyol to form a polyurethane coating.

2. The process as claimed in claim 1, characterized in that the anionic surface-active agent is present in the composition based on isocyanate(s).

3. The process as claimed in claim 1, characterized in that said composition comprising isocyanate(s) does not comprise more than 20% by mass of surfactant in the form bonded to an isocyanate functional group.

4. The process as claimed in claim 1, characterized in that said composition comprising isocyanate(s) does not comprise more than 10% by mass of surfactant in the form bonded to an isocyanate functional group.

5. The process as claimed in claim 1, characterized in that said anionic surface-active agent exhibits at least one functional group selected from sulfates or phosphates of aryl(s) and/or alkyl(s) or aryl- or alkyl-phosphonate, -phosphinate or sulfonate.

6. The process as claimed in claim 1, characterized in that said lipophilic part of the surface-active agent is selected from alkyl and aryl groups.

7. The process as claimed in claim 1, characterized in that the anionic fraction of the surface-active agent corresponds to the following formula: 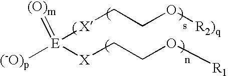
where q is zero or 1;
where p is an integer between 1 and 2 (closed ranges, that is to say comprising the limits);
where m is zero or an integer between 1 and 2 (closed ranges, that is to say comprising the limits);
where X and X′, which are identical or different, each represents an arm comprising at most two carbon chain members;
where s is zero or an integer selected between 1 and 30, advantageously between 5 and 25, preferably between 9 and 20;
where n is zero or an integer selected between 1 and 30, advantageously between 5 and 25, preferably between 9 and 20;
where E is an element selected from phosphorus and sulfur;
where R₁ and R₂, which are identical or different, each represents a hydrocarbon radical advantageously selected from optionally substituted aryls and alkyls;
the countercation being selected from metallic inorganic cations or organic cations.

8. The process as claimed in claim 7, characterized in that said countercation is an ammonium cation originating from a tertiary amine.

9. The process as claimed in claim 8, characterized in that the tertiary amine is triethylamine.

10. The process as claimed in claim 1, characterized in that the surface-active agent which consists of a mixture of phosphoric acid mono- and diesters of polyethoxylated nonylphenol comprising ten ethylenyloxyl units.

11. The process as claimed in claim 1, characterized in that the ratio by mass of the isocyanates to the anionic surface-active agent is at most equal to ⅓, advantageously at most equal to 20%, preferably to 10%, and greater than 1%, advantageously than 2%.

12. The process as claimed in claim 7, characterized in that the amount of said surface-active agent(s) corresponds to a value of between 10⁻² and 1 atom of E per liter.

13. The process as claimed in claim 1, characterized in that the polyisocyanate composition comprising the surface-active agent is added manually to a polyol emulsion.

14. The process as claimed in claim 1, characterized in that the polyol is a polyester polyurethane dispersion.

15. The process as claimed in claim 1, characterized in that the (poly)isocyanate is selected from the products of homo- or heterocondensation of alkylene diisocyanates.

16. The process as claimed in claim 1, characterized in that the molar ratio of the free isocyanate functional groups to the hydroxyl functional groups of the polyol is between 0.5 and 2.5, advantageously between 0.8 and 1.6, preferably between 1 and 1.4.

17. The process as claimed in any one of the preceding claims, characterized in that the coating is applied over a thickness after drying of between 5 and 150 μm, advantageously between 30 and 100 μm.

18. The process as claimed in any one of the preceding claims, characterized in that it comprises a stage of drying from 20 to 60° C. for a time which can range from 15 minutes to 48 hours.
